(19) United States
(12) Patent Application Publication
(10) Pub. No.: US 2016/0042190 A1
(43) Pub. Date: Feb. 11, 2016

(54) PROVIDING ACCESS CONTROL OF APPLICATIONS ON COMPUTING DEVICE BY ESTABLISHING SCREEN PASSCODES THAT ALLOW ACCESS TO DESIGNATED SCREENS WITH DESIGNATED APPLICATIONS

(71) Applicant: International Business Machines Corporation, Armonk, NY (US)

(72) Inventors: Darryl M. Adderly, Morrisville, NC (US); Prasad Kashyap, Apex, NC (US); Brian J. Murray, Raleigh, NC (US); Wenjian Qiao, Cary, NC (US)

(21) Appl. No.: 14/456,157

(22) Filed: Aug. 11, 2014

(51) Int. Cl. G06F 21/62; G06F 21/31

(52) U.S. Cl. CPC G06F 21/629; G06F 21/31

(57) ABSTRACT

A method, computing device and computer program product for providing access control of applications on the computing device. The computing device receives a selection of a set of one or more screens from the owner of the mobile device. The computing device further receives a selection of application(s) to be placed in the selected set of screens. The computing device additionally receives a screen passcode to be assigned to the selected set of screens. The computing device then assigns the received screen passcode to the selected set of screens which enables access to the application(s) on the selected set of screens. In this manner, the owner of the computing device can limit other users' access to certain applications on the computing device by segregating the applications on different sets of screens, where each set of screens is assigned a screen passcode which grants access to that set of screens.

### TECHNICAL FIELD

The present invention relates generally to access control on mobile devices, and more particularly to providing access control of applications on a computing device (e.g., smartphone) by establishing screen passcodes that allow access to designated screens with designated applications.

### BACKGROUND

Mobile devices, which are handheld computing devices, such as smartphones, contain content (e.g., application, data) that is important to the owner of the mobile device. As a result, the owner may desire to limit access to such content.

Typically, mobile devices have an access control mechanism to lock the screen of the mobile device thereby preventing other users, besides the owner of the mobile device, from accessing particular applications and data on the mobile device that the owner desires to be secured. Access control methods include requiring the user to provide an access code, such as a password, a pin number, a swipe pattern, a voice command, etc., to provide access to the mobile device.

It is quite common for young children to borrow their parent's mobile devices to play games. In order to play these games on a locked mobile device, the parent may share the access code with the child. However, the child will then have access to other applications, such as e-mail, social media applications, on the mobile device that the parent does not want the child to access.

Alternatively, the parent may directly input the access code (e.g., password) into the mobile device to unlock the mobile device. However, the child will still have access to all the applications on the mobile device, including applications that the parent may not want the child to have access. Furthermore, the parent will be required to provide the access code every time the mobile device is locked. Requiring the parent to provide the access code every time the mobile device is locked can be time consuming.

Alternatively, in order to allow the child to play games on the mobile device, the parent may simply forgo have any access control on the mobile device. However, all the applications on the mobile device are now freely available to the child as well as to anyone else who has possession of the mobile device.

Unfortunately, there is not currently a means for providing access control to a mobile device to provide security to the applications and data on the mobile device while enabling the owner, such as a parent, to limit other users' access, such as a child, to certain applications on the mobile device.

### BRIEF SUMMARY

In one embodiment of the present invention, a method for providing access control of applications on a computing device comprises receiving a selection of a first set of one or more screens on the computing device. The method further comprises receiving a selection of a first set of one or more applications to be placed in the selected first set of one or more screens. The method additionally comprises receiving a first screen passcode to be assigned to the selected first set of one or more screens. Furthermore, the method comprises assigning, by a processor, the first screen passcode to the selected first set of one or more screens which enables access to the first set of one or more applications on the first set of one or more screens.

Other forms of the embodiment of the method described above are in a computing device and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a hardware configuration of a mobile device for practicing the principles of the present invention in accordance with an embodiment of the present invention; and

FIG. 2 is a flowchart of a method for providing access control of applications on different screens of the mobile device in accordance with an embodiment of the present invention.

### DETAILED DESCRIPTION

The present invention comprises a method, computing device and computer program product for providing access control of applications on the computing device. In one embodiment of the present invention, the computing device receives a selection of a set of one or more screens from the owner of the mobile device. The computing device further receives a selection of a set of one or more applications to be placed in the selected set of screens. The computing device additionally receives a screen passcode to be assigned to the selected set of screens. The computing device then assigns the received screen passcode to the selected set of screens which enables access to the application(s) on the selected set of screens. In this manner, the owner of the computing device can provide access control to the computing device to provide security to the applications and data on the computing device while enabling the owner to limit other users' access to certain applications on the computing device by segregating the applications on different sets of screens, where each set of screens is assigned a screen passcode which grants access to that set of screens.

While the following discusses the present invention in connection with providing access control on mobile devices, the principles of the present invention may be applied to providing access control on non-mobile computing devices. A person of ordinary skill in the art would be capable of applying the principles of the present invention to such implementations. Further, embodiments applying the principles of the present invention to such implementations would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

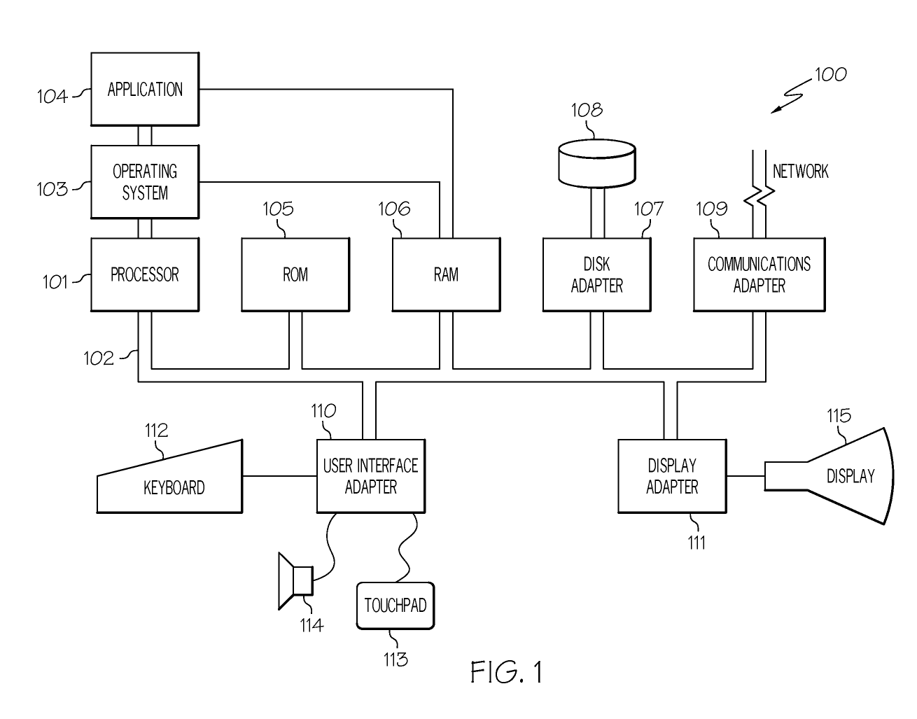

Referring now to the Figures in detail, FIG. 1 illustrates a hardware configuration of mobile device 100 which is representative of a hardware environment for practicing the present invention. Referring to FIG. 1, mobile device 100 has a processor 101 coupled to various other components by system bus 102. An operating system 103 runs on processor 101 and provides control and coordinates the functions of the various components of FIG. 1. An application 104 in accordance with the principles of the present invention runs in conjunction with operating system 103 and provides calls to operating system 103 where the calls implement the various functions or services to be performed by application 104. Application 104 may include, for example, a program for providing access control of applications on different screens of mobile device 100 as discussed further below in connection with FIG. 1.

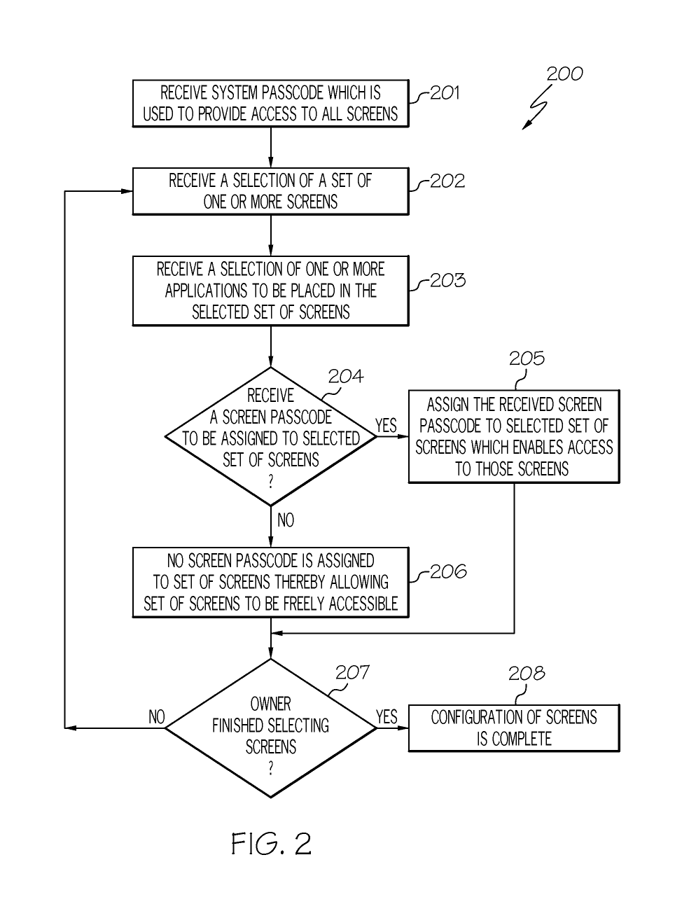

Referring again to FIG. 1, read-only memory (“ROM”) 105 is coupled to system bus 102 and includes a basic input/output system (“BIOS”) that controls certain basic functions of mobile device 100. Random access memory (“RAM”) 106 and disk adapter 107 are also coupled to system bus 102. It should be noted that software components including operating system 103 and application 104 may be loaded into RAM 106, which may be mobile device's 100 main memory for execution. Disk adapter 107 may be an integrated drive electronics (“IDE”) adapter that communicates with a disk unit 108, e.g., disk drive. It is noted that the program for providing access control of applications on different screens of mobile device 100, as discussed further below in association with FIG. 2, may reside in disk unit 108 or in application 104.

Mobile device 100 may further include a communications adapter 109 coupled to bus 102. Communications adapter 109 interconnects bus 102 with an outside network thereby enabling mobile device 100 to communicate with other devices.

I/O devices may also be connected to mobile device 100 via a user interface adapter 110 and a display adapter 111. Keyboard 112, touchpad 113 and speaker 114 may all be interconnected to bus 102 through user interface adapter 110. A display monitor 115 may be connected to system bus 102 by display adapter 111. In this manner, a user is capable of inputting to mobile device 100 through keyboard 112 or touchpad 113 and receiving output from mobile device 100 via display 115 or speaker 114. Other input mechanisms may be used to input data to mobile device 100 that are not shown in FIG. 1, such as display 115 having touch-screen capability and keyboard 112 being a virtual keyboard. Mobile device 100 of FIG. 1 is not to be limited in scope to the elements depicted in FIG. 1 and may include fewer or additional elements than depicted in FIG. 1.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated in the Background section, typically, mobile devices have an access control mechanism to lock the screen of the mobile device thereby preventing other users, besides the owner of the mobile device, from accessing particular applications and data on the mobile device that the owner desires to be secured. Access control methods include requiring the user to provide an access code, such as a password, a pin number, a swipe pattern, a voice command, etc., to provide access to the mobile device. It is quite common for young children to borrow their parent's mobile devices to play games. In order to play these games on a locked mobile device, the parent may share the access code with the child. However, the child will then have access to other applications, such as e-mail, social media applications, on the mobile device that the parent does not want the child to access. Alternatively, the parent may directly input the access code (e.g., password) into the mobile device to unlock the mobile device. However, the child will still have access to all the applications on the mobile device, including applications that the parent may not want the child to have access. Furthermore, the parent will be required to provide the access code every time the mobile device is locked. Requiring the parent to provide the access code every time the mobile device is locked can be time consuming. Alternatively, in order to allow the child to play games on the mobile device, the parent may simply forgo have any access control on the mobile device. However, all the applications on the mobile device are now freely available to the child as well as to anyone else who has possession of the mobile device. Unfortunately, there is not currently a means for providing access control to a mobile device to provide security to the applications and data on the mobile device while enabling the owner, such as a parent, to limit other users' access, such as a child, to certain applications on the mobile device.

The principles of the present invention provide a means for providing access control to the mobile device while enabling the owner of the mobile device, such as a parent, to limit other users' access (e.g., child's access) to certain applications on the mobile device by segregating the applications on different sets of screens and providing access control to those screens containing applications desired to be secured via screen passcodes as discussed below in connection with FIG. 2.

FIG. 2 is a flowchart of a method 200 for providing access control of applications on different screens of mobile device 100 (FIG. 1) in accordance with an embodiment of the present invention.

Referring to FIG. 2, in conjunction with FIG. 1, in step 201, mobile device 100 receives a “system passcode” from the owner of mobile device 100 which is used to provide access to all the screens on mobile device 100. Each screen on mobile device 100 may include various applications, which may be designated by the owner of mobile device 100. A “system passcode,” as used herein, refers to a passcode that allows access to all the screens, applications, settings, functions, etc. of mobile device. A “passcode,” as used herein, refers to user input, such as a keyboard entry, a pin number, a pattern gesture, a swipe pattern, a vocal command, a voice pattern and a facial feature, that is used to authenticate the user to provide access to mobile device 100. In one embodiment, the system passcode is stored in a data structure that may reside in memory or storage on mobile device 100 (e.g., memory 105, 106, disk unit 108). In one embodiment, the program of the present invention that provides access control of applications on different screens may present a graphical user interface (GUI) to enable the owner of mobile device 100 to enter the system passcode as well as other information (e.g., selection of screens, selection of applications, screen passcodes, etc.) as discussed herein.

In step 202, mobile device 100 receives a selection of a set of one or more screens from the owner of mobile device 100. For example, the owner of mobile device 100 may select screens #3 and #4.

In step 203, mobile device 100 receives a selection of application(s) to be placed in the selected set of screens. As used herein, a “set of screens” can include one or more screens. For example, the owner of mobile device 100 may select various game applications for older children to be placed in screens #3 and #4.

In step 204, a determination is made by mobile device 100 as to whether it received a screen passcode from the owner of mobile device 100 to be assigned to the selected set of screens. A “screen passcode,” as used herein, refers to a passcode that is assigned to a particular set of screens, including a single screen. The screen passcode is used to control access to those applications on the screen(s) associated with the assigned screen passcode. In this manner, the user can only access those applications by providing the correct screen passcode to access those screen(s) containing those applications. If the owner does not assign a screen passcode to the selected set of screens, then any user will be able to freely access those applications on those screens.

If mobile device 100 receives a screen passcode from the owner of mobile device 100 to be assigned to the selected set of screens, then, in step 205, mobile device 100 assigns the received screen passcode to the selected set of screens which enables access to those screens. In one embodiment, the screen passcode along with the associated screen(s) are stored in a data structure that may reside in memory or storage on mobile device 100 (e.g., memory 105, 106, disk unit 108). For example, the owner of mobile device 100 may assign a screen passcode to access screens #3 and #4 which contain game applications for older children so that the owner's younger children will not be able to access these game applications.

If, however, the user does not assign a screen passcode to the selected set of screens, then, in step 206, mobile device 100 does not assign a screen passcode to the selected set of screens thereby allowing this set of screens to be freely accessible. For example, the owner of mobile device 100 may not assign a screen passcode to access screens #5 and #6 since these screens contain applications, such as game applications for young children, that all children (and others) can freely access.

Upon assigning the received screen passcode to the selected set of screens in step 205, or upon not assigning a screen passcode to the selected set of screens in step 206, a determination is made, in step 207, by mobile device 100 as to whether the owner of mobile device 100 has finished selecting screens. If the owner has not finished selecting screens, then mobile device 100 receives a selection of a set of one or more additional screens from the owner of mobile device 100 in step 202.

If, however, the owner has finished selecting screens, then, in step 208, mobile device 100 has completed configuration of the screens of mobile device 100.

In this manner, the owner of a mobile device can provide access control to the mobile device to provide security to the applications and data on the mobile device while limiting other users' access to certain applications on the mobile device by segregating the applications on different sets of screens, where each set of screen(s) is assigned a screen passcode which grants access to that set of screen(s). The screen passcode protects and unlocks the associated set of screen(s) as opposed to protecting and unlocking the entire device. Furthermore, the owner of the mobile device is able to control the accessibility of the applications by placing them in different sets of screens assigned with different screen passcodes thereby allowing the owner of the mobile device to designate different users with different access rights (rights to access different applications).

For example, suppose a user that has possession of the mobile device does not have any knowledge of any screen passcodes. The user swipes to unlock the mobile device. The user is presented with the first screen in a set of screens (e.g., screens #1 and #2) that has not been assigned a screen passcode thereby indicating that such screens are to be freely accessible. The user may continue to swipe to see the next screen. The user will eventually be required to enter a screen passcode once the user has viewed all of the screens that are freely accessible. The user will not be able to view any additional screens unless the user enters the appropriate screen passcode.

Continuing with the above example, a second user that has possession of the mobile device may have knowledge of screen passcode #1 which grants access to screens #3 and #4. The second user will be able to view screens #1 and #2 as well as screens #3 and #4 once the second user enters screen passcode #1. The second user now has access to the applications placed on screens #1, #2, #3 and #4 by the owner of the mobile device. If the second user attempts to swipe to screen #5, the second user will be presented with a request to enter a screen passcode assigned to screen #5.

As discussed above, the owner of the mobile device provided a system passcode to the mobile device in step 201 of FIG. 2. When the owner of the mobile device enters a system passcode, the owner will have access to all the screens, including screens #1, #2, #3, #4 and #5.

In some implementations, method 200 may include other and/or additional steps that, for clarity, are not depicted. Furthermore, in some implementations, method 200 may be executed in a different order than presented. Additionally, in some implementations, certain steps in method 200 may be executed in a substantially simultaneous manner or may be omitted. For example, the owner may select the screen(s) and the application(s) to be placed in those selected screen(s) in either order, including concurrently. Furthermore, the owner may have preconfigured the screen(s) to include designated application(s) thereby negating the requirement of having the owner select the applications to be placed in the selected screen(s) after selecting the screen(s) to be assigned or not be assigned a screen passcode.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-6. (canceled)

7. A computer program product for providing access control of applications on a computing device, the computer program product comprising a computer readable storage medium having program code embodied therewith, the program code comprising the programming instructions for:
receiving a selection of a first set of one or more screens on said computing device;
receiving a selection of a first set of one or more applications to be placed in said selected first set of one or more screens;
receiving a first screen passcode to be assigned to said selected first set of one or more screens; and
assigning said first screen passcode to said selected first set of one or more screens which enables access to said first set of one or more applications on said first set of one or more screens.

8. The computer program product as recited in claim 7, wherein the program code further comprises the programming instructions for:
receiving a system passcode which is used to provide access to all screens on said computing device.

9. The computer program product as recited in claim 7, wherein the program code further comprises the programming instructions for:
receiving a selection of a second set of one or more screens on said computing device;
receiving a selection of a second set of one or more applications to be placed in said selected second set of one or more screens; and
assigning a second screen passcode to said selected second set of one or more screens which enables access to said second set of one or more applications on said second set of one or more screens.

10. The computer program product as recited in claim 7, wherein said screen passcode comprises one or more of the following: keyboard entry, pin number, pattern gesture, swipe pattern, vocal command, voice pattern and facial feature.

11. The computer program product as recited in claim 7, wherein the program code further comprises the programming instructions for:
receiving a selection of a second set of one or more screens on said computing device;
receiving a selection of a second set of one or more applications to be placed in said selected second set of one or more screens; and
not assigning a screen passcode to said selected second set of one or more screens thereby enabling said second set of one or more applications on said second set of one or more screens to be freely accessible.

12. The computer program product as recited in claim 7, wherein said computing device is a mobile device.

13. A computing device, comprising:
a memory unit for storing a computer program for providing access control of applications on said computing device; and
a processor coupled to the memory unit, wherein the processor is configured to execute the program instructions of the computer program comprising:
receiving a selection of a first set of one or more screens on said computing device;
receiving a selection of a first set of one or more applications to be placed in said selected first set of one or more screens;
receiving a first screen passcode to be assigned to said selected first set of one or more screens; and
assigning said first screen passcode to said selected first set of one or more screens which enables access to said first set of one or more applications on said first set of one or more screens.

14. The computing device as recited in claim 13, wherein the program instructions of the computer program further comprises:
receiving a system passcode which is used to provide access to all screens on said computing device.

15. The computing device as recited in claim 13, wherein the program instructions of the computer program further comprises:
receiving a selection of a second set of one or more screens on said computing device;
receiving a selection of a second set of one or more applications to be placed in said selected second set of one or more screens; and
assigning a second screen passcode to said selected second set of one or more screens which enables access to said second set of one or more applications on said second set of one or more screens.

16. The computing device as recited in claim 13, wherein said screen passcode comprises one or more of the following: keyboard entry, pin number, pattern gesture, swipe pattern, vocal command, voice pattern and facial feature.

17. The computing device as recited in claim 13, wherein the program instructions of the computer program further comprises:
receiving a selection of a second set of one or more screens on said computing device;
receiving a selection of a second set of one or more applications to be placed in said selected second set of one or more screens; and
not assigning a screen passcode to said selected second set of one or more screens thereby enabling said second set of one or more applications on said second set of one or more screens to be freely accessible.

18. The computing device as recited in claim 13, wherein said computing device is a mobile device.
